(19) United States
(12) Patent Application Publication
(10) Pub. No.: US 2012/0204792 A1
(43) Pub. Date: Aug. 16, 2012

(54) CABLE INSCRIPTION DEVICE AND METHOD FOR INSCRIBING CABLES

(75) Inventor: Dirk Schnur, Wuppertal (DE)

(73) Assignee: SCHLEUNIGER HOLDING AG, Thun (CH)

(21) Appl. No.: 13/386,430

(22) PCT Filed: Nov. 5, 2010
(86) PCT No.: PCT/IB2010/055034

§ 371 Date: Jan. 25, 2012

Related U.S. Application Data
(60) Provisional application No. 61/259,114, filed on Nov. 6, 2009.

(30) Foreign Application Priority Data
Nov. 6, 2009 (CH) 01714/09

(51) Int. Cl. B05C 5/02; B05C 11/00

(52) U.S. Cl. 118/696; 118/323

(57) ABSTRACT

An apparatus (1) and method for inscribing a cable (2) moving along its axis (y) are described. The apparatus (1) comprises a jet/beam generator (3) for generating at least one jet/beam (A) which produces the inscription. Furthermore, the apparatus (1) comprises a movement unit which is prepared for moving the at least one jet/beam (A) during the inscription process in the direction (a) transverse to the cable axis (y). The movement unit may adjust the direction of movement (a) continuously in such a way that the speed component (VSy) of the jet/beam movement in the region of the cable (2) in the direction of the cable axis (y) corresponds to the speed (VL) of the cable (2).

This application is a 35 U.S.C. sec. 371 national-phase entry of PCT International application number PCT/IB2010/055034 filed on Nov. 5, 2010 and published as WO 2011/055336A1 on May 12, 2011; PCT International application number PCT/IB2010/055034 claims benefit as a nonprovisional of prior U.S. provisional application No. 61/259,114 filed on Nov. 6, 2009, and also claims benefit of priority to prior Swiss national application no. 01714/09 filed on Nov. 6, 2009; the entireties of parent application no. PCT/IB2010/055034, of Swiss application no. 01714/09, and of U.S. application Ser. No. 61/259,114 are expressly incorporated herein by reference all in their entirety, for all intents and purposes, as if identically set forth in full herein.

The invention relates to an apparatus for inscribing a cable moving along its axis, comprising a jet generator for generating at least one jet which produces the inscription, and a movement unit which is prepared for moving the at least one jet during the inscription process in a direction transverse to the cable axis. The invention furthermore relates to a method for inscribing a cable moving along its axis, at least one jet which produces the inscription being generated and being moved in a direction transverse to the cable axis during the inscription process.

In modern technology, a multiplicity of cables is required, for example cables for power distribution and for signal transmission. Frequently, these cables are produced as continuous material with often circular cross-sections. In order to facilitate the further processing of said cables, they are generally inscribed, for example with respect to type (e.g. “cable Cu 1.5 mm2”) or with respect to their use (e.g. “connecting cable motor/control”). Inscription with machine-readable codes or price data is also usual.

For example, U.S. Pat. No. 5,285,723 A discloses in this context an inscription system for cables, in which a printing head can be moved transversely to the direction of movement of a transported cable in order thus to print on various cables running parallel through the machine.

Furthermore, DE 10 2004 029 649 B4 discloses an apparatus for printing on cables with two printing heads, in which ink droplets are deflected with the aid of an electric field in order thus to print any desired pattern on the cable.

Unfortunately, the apparatuses known from the prior art frequently give results which are not very satisfactory since the increasingly high transport speed in the production or in the further processing of said cables means that the inscription does not always take place in the desired manner because, for example, it is blurred. This is because, for example, the ink droplets of an inkjet printing head strike the cable after a time lag owing to the line-by-line production of the inscription. However, since the cable is moved, this causes an undesired offset of the picture elements produced on the cable and hence an obliquely blurred inscribed image. As a result of this, the purchaser of the cable in certain circumstances makes an undesired and possibly also unjustified low valuation of the goods. In the extreme case, the inscription is completely unusable if it can no longer be read by man and machine.

The object of the present invention is to provide an apparatus and a method which permits inscription of cables with high quality.

According to the invention, this object is achieved by an apparatus of the type mentioned at the outset, in which the movement unit is additionally prepared for continuously adjusting the direction of movement of the jet in such a way that the speed component of the jet movement in the region of the cable in the direction of the cable axis corresponds to the speed of the cable.

Furthermore, this object is achieved by a method of the type mentioned at the outset, in which the direction of movement of the jet is continuously adjusted in such a way that the speed component of the jet movement in the region of the cable in the direction of the cable axis corresponds to the speed of the cable.

According to the invention, a line is therefore applied not at right angles to the axis of the cable, as is usual, but somewhat obliquely thereto. The angle between the direction of movement of the jet and the cable axis depends on the speed of the cable and the speed of movement of the jet. The higher the speed of the cable in comparison with the speed of movement of the jet, the more acute is said angle. With the aid of the invention, the cable to be inscribed can therefore now advantageously be further moved uniformly even during the printing process and need not be stopped for each line and then moved a section onwards.

Since the apparatus according to the invention requires only little space, it is suitable in particular for use in the limited space of a cable processing machine in which cables are, for example, inscribed, cut to length, provided with crimp contacts and packed at high speed.

In the printing of cables on fully automatic crimping machines, the following conditions usually apply:
The cable is not transported at constant speed but is first accelerated from the rest state, transported at constant, high speed and then slowed down to rest.
The inscription can be effected in the acceleration/deceleration phases and also during the transport phases at high speed.

According to the invention, the adjustment of the direction of movement of the jet is effected continuously so that an undistorted inscription is always applied to the cable, regardless of whether it is moved uniformly, accelerated or slowed down.

Manually adjustable holders known according to the prior art for printing heads are on the other hand adjusted so that a readily legible inscription results. The matching of cable transport speed and adjustment of angle of rotation of the printing head is therefore a compromise in the case of manual adjustment.

“Inscription” is any meaningful surface configuration of the cable. Thus, this definition covers not only characters in the narrower sense but, for example, also symbols, pictograms, one- or two-dimensional barcodes and the like.

In the context of the invention, “jet movement in the region of the cable” is to be understood as meaning the speed of the point of intersection of the jet with a plane spanning the cable or with the surface of the cable.

Advantageous configurations and further developments of the invention shall be evident from the description together with the figures of the drawing.

It is advantageous if the movement unit is prepared for displacing an exit point of the jet from the jet generator along one or two axes in space. In this variant of the invention, the exit point of the jet is therefore displaced translationally. This is most simply effected by a carriage which can travel along an axis in space or by two carriages arranged transversely to one another to provide serial kinematics. In this variant of the invention, the direction of the jet can remain constant per se.

It is also advantageous if the movement unit is prepared for changing the direction of the jet in one or two axes in space. In this variant of the invention, the direction of the jet is changed either by pivoting the jet generator or by deflecting the jet which has emerged from the jet generator. This in turn can be effected either in one axis in space (the jet then moves in a plane) or in two axes in space. In this variant of the invention, the jet exit point can be stationary per se.

In an advantageous variant of the invention, the movement unit comprises:
a line movement unit which is set up for moving the jet in a plane transverse to the cable axis and
an adjustment unit which is set up for adjusting the line movement unit and hence said plane relative to the cable axis in such a way that the speed component of the jet movement in the region of the cable in the direction of the cable axis corresponds to the speed of the cable.
   In this design of the apparatus according to the invention, the movement unit is divided into a line movement unit and an adjustment unit. The line movement unit moves the jet transversely to the cable axis and thus ensures a line-by-line or column-by-column structure of the inscription. The jet is moved (relatively rapidly) back and forth in a plane. With the aid of the adjustment unit, the line movement unit can now be set up so that the plane in which the jet is moved is rotated slightly relative to the cable axis. At a certain setting, the speed component of the jet movement in the region of the cable in the direction of the cable axis corresponds to the speed of the cable. At this setting, the jet is guided behind the moving cable so that, in spite of the movement of the cable, an undistorted inscription is applied thereon.

It is particularly advantageous if a connecting line between the jet exit point and the point of intersection of the cable axis with said plane makes a right angle with the cable axis. The plane in which the jet is moved is therefore rotated relative to the cable axis about an axis normal to said cable axis. The advantage of this variant is that, at least in one position of the jet, an undistorted picture element (a pixel) is applied to the cable.

It is furthermore advantageous if the jet provided is an intermittent liquid jet. In this variant, the image is thus produced with the aid of an ink jet. These methods are known per se, but known methods differ in that the medium to be printed on (i.e. for example a sheet of paper) is advanced line by line and therefore nonuniformly during the printing process. In contrast, cables are as a rule moved as uniformly as possible or at least not in such a jerky manner as a sheet of paper during the production process, since the resulting acceleration forces might in certain circumstances damage the cables, for example if the cable is unwound from a heavy roll. In this case, the “jet” can be considered as a series of ink droplets.

It is particularly advantageous if the liquid jet is electrically charged and the movement unit is set up for deflecting the liquid jet with the aid of a variable electrostatic field. In this version, the electrically charged ink jet is deflected with the aid of an electrostatic field so that the jet exit point (i.e. the nozzle) can be stationary per se. Thus, no accelerations act on the jet generator (i.e. the printing head), although the jet can be very rapidly controlled in different directions.

In a further advantageous configuration of the invention, the jet provided is an intermittent laser beam. In this variant, an inscription is therefore applied with the aid of a light beam. Optionally, a (photosensitive) coating can be provided on the cable to be inscribed, in order to facilitate or to permit the inscription. The inscription can, however, also be effected by removing a little material from the sheath of the cable. For example, a small pit can be burned in the sheath for each pixel by means of a synchronized laser.

In a further advantageous variant of the invention, the apparatus comprises a spacer unit which is prepared for changing the spacing between the exit point of the jet from the jet generator and the cable. In this way, the inscription could likewise be changed. For example, a greater spacing between jet exit point and cable in the case of a divergent jet ensures that a picture element (a pixel) becomes larger. Conversely, decreasing the spacing ensures smaller picture elements. If the direction of the jet is changed during the inscription process, the size of the inscription is then also determined by the distance between the jet exit point and the cable. Increasing the spacing leads to larger inscriptions and reducing the spacing leads to smaller inscriptions.

In a further advantageous variant of the invention, the apparatus according to the invention comprises a memory unit which is prepared for storing one or more parameters from the group: direction of movement of the jet, spacing between the exit point of the jet from the jet generator and the cable, size of the inscription, offset of the inscription relative to the cable axis for a certain type of cable. Such a memory unit may be provided as a machine-readable medium having stored thereon data which may be used by a computer or other electronic devices to effect control according to the invention. It is preferred to store data on the hard disc drive of the computer which is part of the machine control. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions, or combinations thereof. Moreover, stored data may also be downloaded as computer data, wherein the data may be transferred from a remote computer memory to a requesting computer by way of data signals embodied in a carrier wave or other propagation medium via a communication link (e.g., a modem or network connection). In this way, parameters which influence the inscription can be stored for a plurality of cable types and called up if required so that, for example, the jet generator, the movement unit, the line movement unit, the adjustment unit and the spacer unit are moved on the basis of the stored parameters to a position advantageous for a certain cable type. Since the settings are made by actuators, tedious manual setup work can be avoided. Regarding the type of cable, it is also possible to consider only the cross-section and/or speed thereof. This means, for example, that for two essentially different cable types which, however, have the same diameter, it is possible to load the same parameter set.

In a further advantageous variant of the invention, the apparatus according to the invention finally comprises a means for calculating one or more parameters from the group: direction of movement of the jet, spacing between the exit point of the jet from the jet generator and the cable, size of the inscription, offset of the inscription relative to the cable axis, on the basis of at least one parameter characterizing the cable. Such means for calculating may comprise hardware components or may be embodied in machine-executable instructions, which may be utilized to cause a general-purpose or special-purpose processor programmed with the instructions to perform the calculations. The calculations may be performed by a combination of hardware, software, and/or firmware. Such means may, for example, comprise, but are not exclusively limited to, a workstation, programmable logic controller, programmable gate array, personal computer, client or server, upon which or with which calculation of parameters according to the present invention may be effected. In this variant, said parameters are calculated instead of being stored in a fixed manner. For example, the spacing between the exit point of the jet from the jet generator and the cable can be determined as 1.5 times the cable diameter. Of course, not only are simple multiplications by a factor possible but also more complicated formulae. Furthermore, mixed forms between this variant and the abovementioned variant are also conceivable, for example if constants for groups of cable types assume different values. For example, it is conceivable to specify the script size for cable diameters of 0 to 2 mm as 0.8, of 2 to 5 as 0.7 and above this as 0.5·diameter.

By combination of stored parameter sets or calculation thereof with actuators, the setup parameters of the printing head holder can thus be fully automatically set and, during transport of the cable, automatically adjusted “on the fly” according to the respective transport speed in the successive processing of cables having different cross-sections, different lengths or different printing areas.

At this point, it should be noted that the variants mentioned for the apparatus according to the invention and advantages resulting therefrom relate equally to the method according to the invention, and vice versa.

The above configurations and further developments of the invention can be combined in any desired manner.

The present invention is explained in more detail below with reference to working examples given in the schematic figures of the drawing.

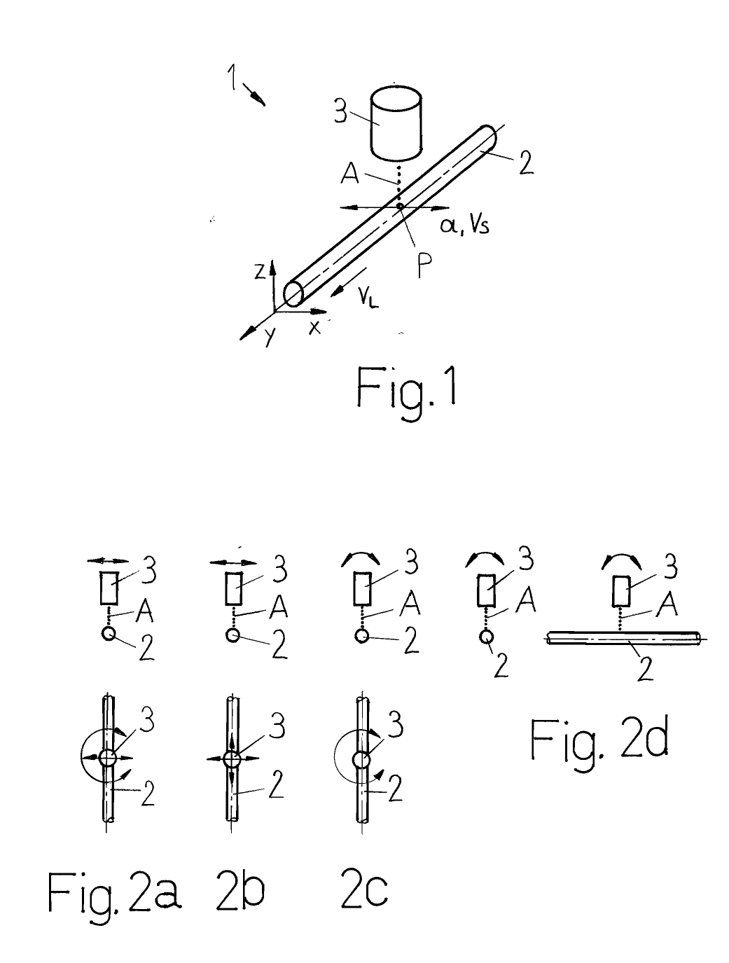

FIG. 1 shows a greatly simplified apparatus for inscription of a cable moved along its axis, as an oblique view;

FIG. 2a schematically shows an apparatus according to the invention in which a jet generator is displaced transversely to the axis of the cable, as a front view and plan view;

FIG. 2b is the same as FIG. 2a but with a jet generator moved along two axes;

FIG. 2c is the same as FIG. 2a but with a jet whose direction can be changed in an axis;

FIG. 2d is the same as FIG. 2c but with a jet whose direction can be changed in two axes, as a front view and side view;

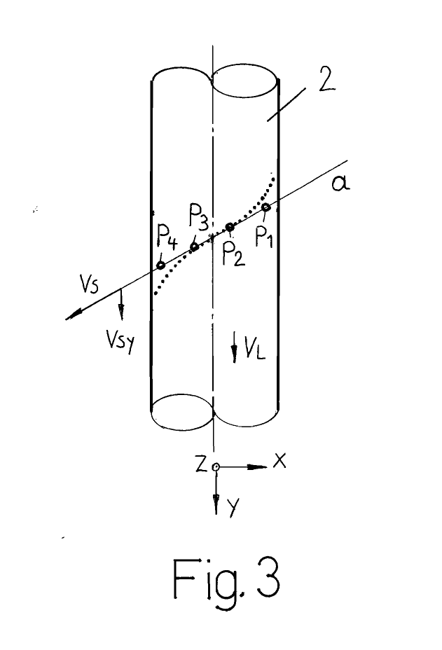

FIG. 3 shows an adjustment, according to the invention, of the direction of movement of the inscription jet.

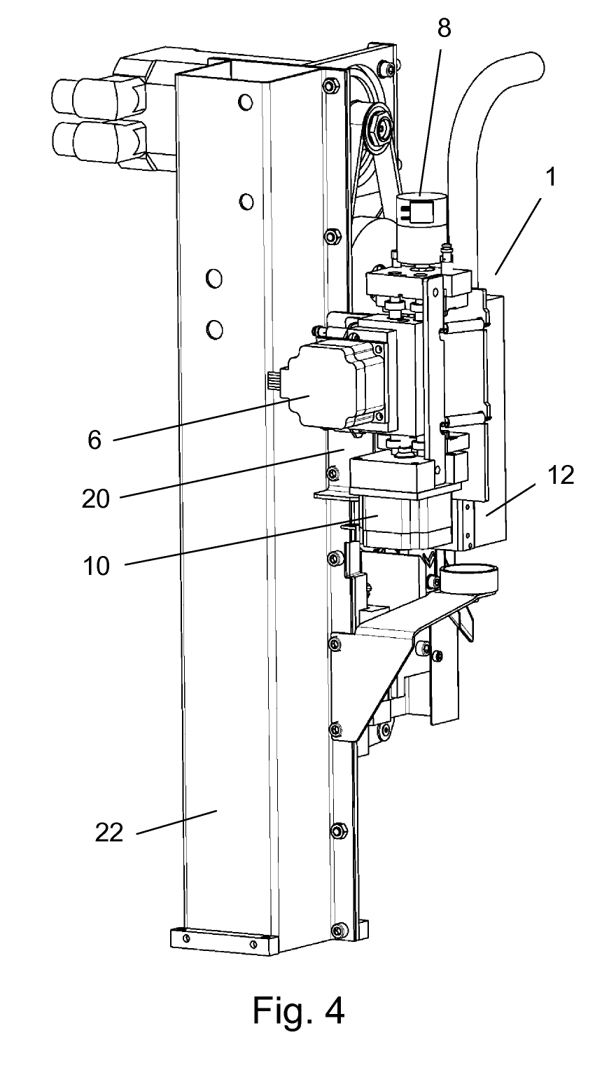

FIG. 4 depicts in side perspective an exemplary implementation according to versions of the invention.

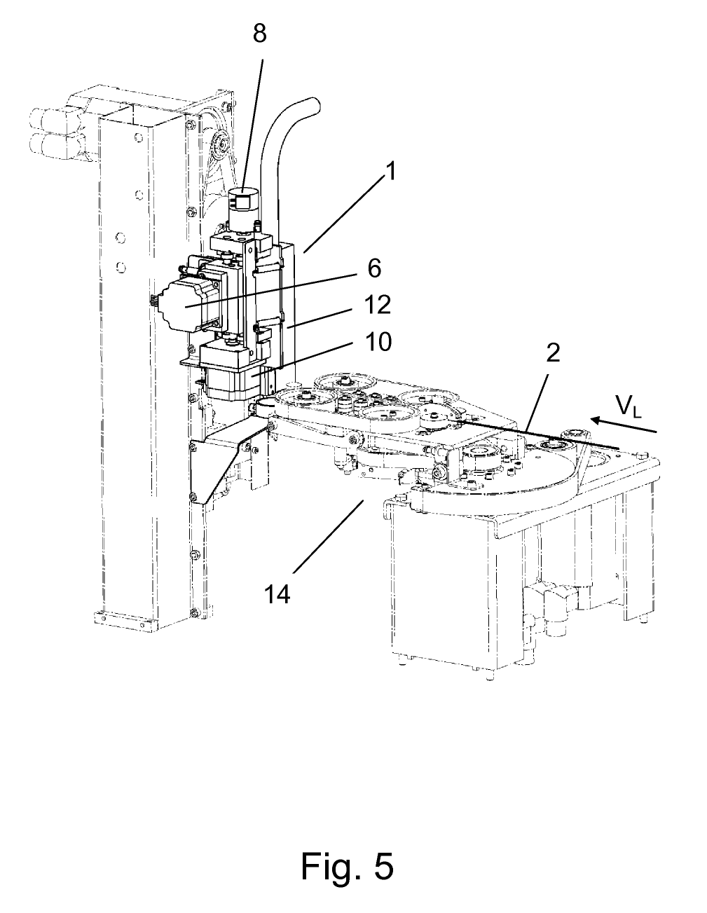

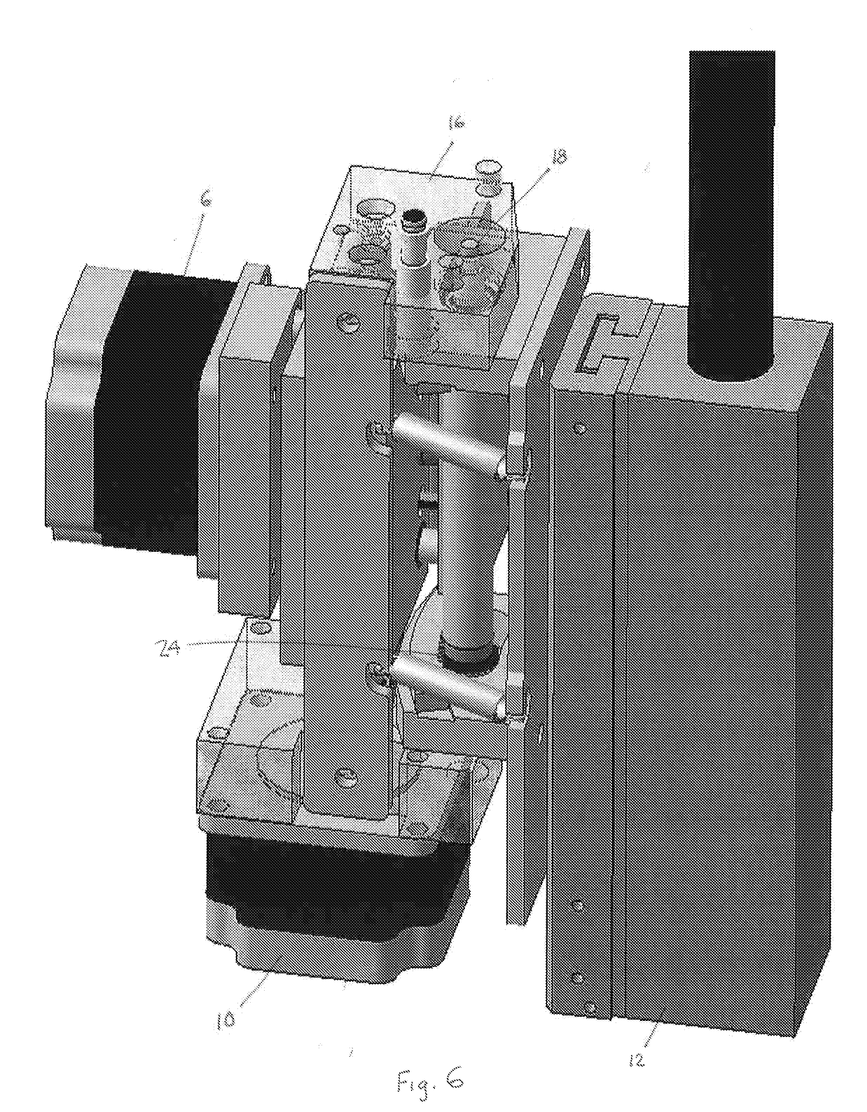

FIG. 5 depicts a similar side perspective of an exemplary implementation according to versions of the invention, in which the location and orientation of a cable driving unit is indicated.

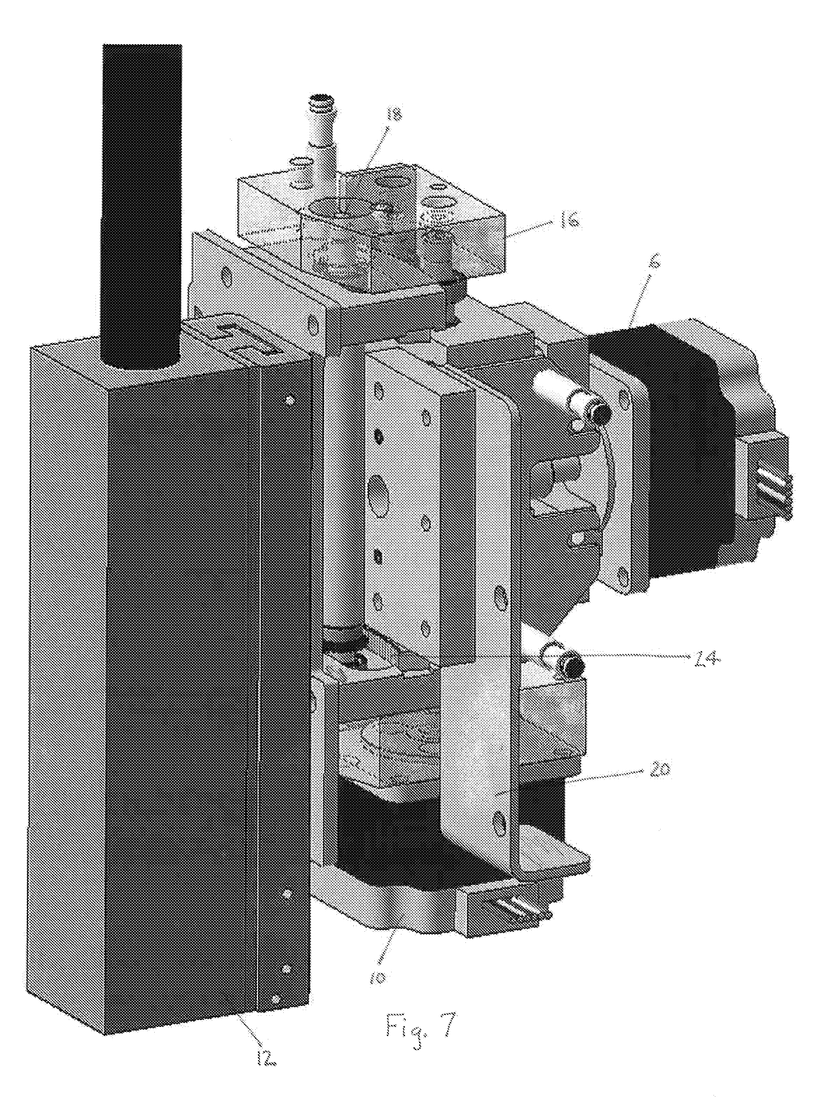

FIGS. 6-7 depict, in elevational perspective isolations taken from opposite sides, an exemplary implementation according to versions of the invention.

In the figures of the drawing, identical and similar parts are provided with identical reference numerals and functionally similar elements and features—unless stated otherwise—are provided with identical reference numerals and possibly different indices.

FIG. 1 shows, in a greatly simplified manner, an apparatus 1 for inscribing a cable 2 moved along its axis y. The apparatus 1 comprises of a jet generator 3 for producing at least one jet A which produces the inscription.

The apparatus 1 furthermore comprises a movement unit which is prepared for moving the at least one jet A during the inscription process at a speed VS in a direction a transverse to the cable axis y. The movement unit itself is not shown in FIG. 1, but the jet movement is shown in the form of a picture element P moved in the direction a.

FIGS. 2a and 2b show how an exit point of the jet A from the jet generator 3 can be displaced in one or two axes in space. The figures show the cable 2 and the jet generator 3 in each case as a front view and plan view. FIG. 2a shows a variant in which the jet A can be displaced along an axis a, and FIG. 2b shows a variant in which the jet A can be displaced along two axes x and y.

FIGS. 2c and 2d show how the direction of the jet A can be changed in one or two axes in space. FIG. 2c shows the cable 2 and the jet generator 3 as a front view and plan view, and FIG. 2d shows them as a front view and side view. FIG. 2c shows a variant in which the direction of the jet A can be changed along an axis a or in a plane which contains the jet exit point and the axis a. FIG. 2d shows a variant in which the direction of the jet A can be changed arbitrarily along the two axes x and y and therefore in space.

FIGS. 2a and 2c additionally indicate the possibility of rotating the direction a, in which the beam A is moved, relative to the cable axis y. This can be effected, for example, by rotating the jet generator 3 about its vertical axis z.

Of course, combinations of the variants shown are also conceivable. For example, the variant from FIG. 2b can be combined with the variant from FIG. 2d if a pivot movement is provided instead of a translational movement for one of the two directions.

For example, an intermittent liquid jet can be provided as jet A. The jet generator 3 then corresponds to an inkjet printing head having at least one nozzle.

The printing head 3 and hence the jet A are displaced during the inscription process (cf. FIGS. 2a and 2b) or the jet A is changed in its direction (cf. FIGS. 2c and 2b), whether by pivoting of the printing head 3 or by means of a variable electrostatic field if the ink is electrically charged.

Moreover, an intermittent laser beam can be provided as beam A. The beam generator 3 then corresponds to a laser generator. The laser generator 3 and hence the beam A are once again displaced during the inscription process (cf. FIGS. 2a and 2b) or the beam A is changed in its direction (cf. FIGS. 2c and 2d), for example by pivoting of the laser generator 3 or by provision of a rotatably mounted mirror.

FIG. 3 shows how said direction of movement a is adjusted according to the invention in such a way that the speed component VSy of the jet movement in the region of the cable 2 in the direction of the cable axis y corresponds to the speed VL of the cable 2. The picture elements or pixels P1 . . . P4 applied in succession as a function of time are applied to the cable 2 obliquely in a global coordinate system but at right angles to the cable axis y in a cable coordinate system, owing to VSy. Although the cable 2 is moved uniformly below the printing apparatus 1 according to the invention, a distortion-free inscription can be applied.

The movement of the jet A can be brought about in various ways. For example, the movement unit comprises a line movement unit which is set up for moving the jet A in a plane (defined by the direction of the jet movement a and the jet exit point in FIG. 3) transverse to the cable axis y. Furthermore, the movement unit comprises an adjustment unit which is set up for adjusting the line movement unit and hence said plane relative to the cable axis y in such a way that the speed component VSy of the jet movement in the region of the cable 2 in the direction of the cable axis y corresponds to the speed VL of the cable 2. For example, the variants shown in FIG. 2a and FIG. 2c can be used for this purpose.

In the case of a variant according to FIG. 2a, the jet generator 3 is moved, for example, with the aid of a carriage which can travel along the axis a. If this axis a is pivoted as shown in FIG. 3, for example by pivoting of the guide rails for said carriage, a distortion-free inscription can be produced.

However, the arrangement shown in FIG. 2c is also suitable for this variant of the invention. Here, the jet A can be changed along an axis a or in a plane which is defined by the direction of the jet movement a and the jet exit point. For this purpose, for example, the jet generator 3 can be rotated about an axis which is oriented normal to the jet movement direction a. If this axis of rotation is pivoted about the z axis, the direction of movement of the jet A can once again be correspondingly adjusted. For the same purpose and to the same effect, the jet/beam A can also be deflected, for example by a rotatably mounted mirror if a laser beam is provided for the beam A or, for example, by an electric field if an electrically charged inkjet is provided for the jet A. The actuators, i.e. substantially two pole plates which generate the electric field in the jet/beam movement direction a, can likewise be pivoted about the z axis.

While in the case of the designs according to FIGS. 2a and 2c the orientation of a line movement unit is adjusted, the jet A in the case of the designs according to FIGS. 2b and 2d can be moved completely freely, for example displaced by two carriages arranged transversely to one another and on which the jet generator 3 is displaced (FIG. 2b). In the case of the variant according to FIG. 2d, the jet/beam A is deflected in two different directions, for example with the aid of a cardanically mounted jet/beam generator 3, with the aid of a cardanically mounted mirror if a laser beam is provided for the beam A or with the aid of an electric field variable in two axes if an electrically charged inkjet is provided for the jet A.

Strictly speaking, the speed VS of the jet movement in FIG. 3 corresponds to the speed of the picture elements P1 . . . P4. In the case of the variants according to FIGS. 2a and 2b, this corresponds to the speed of the translationally moved jet exit point. In the case of the variants according to FIGS. 2c and 2d, the point of intersection of the jet A with a plane spanning the cable 2 should be used for this purpose.

Since the cables 2 generally have a circular cross-section, the movement of the jet A along a straight line in the direction a does not, strictly speaking, lead to a completely distortion-free inscription. If the cylindrical cross-section is also to be taken into account, a S-shaped, in particular sinusoidal, curve oriented in the direction a can be provided, instead of a straight line, for the movement of the jet A in the case of an advantageous variant of the invention. This curve is shown as a dotted line in FIG. 3. Since, for example, an ink droplet on the outside of cable 2 requires a longer “time of flight”, the jet A is caused to make a further tracking movement in this embodiment. In the case of the inscription of cables 2 with the aid of laser light, this effect can, however, be neglected owing to the high speed of light in comparison with the cable speed VL.

FIG. 4 depicts an exemplary implementation of apparatus 1 according to versions of the invention, by way of non-limiting example. Such an apparatus 1 includes a typical frame 22 upon which other components may be mounted via one or more mounting plates 20 or analogous hardware. The jet/beam generator 3 is situated in an inscribing module 12. For the rapid understanding of the integration of apparatus 1 in the entire cable processing environment, reference is made to FIG. 5 that indicates an appropriate relative disposition of an otherwise conventional cable driving unit 14. As may be understood from accompanying FIG. 5, a cable 2 advances with the forementioned speeds VL towards apparatus 1 via cable driving unit 14.

In versions of the invention that include a line movement unit 6, such is appropriately disposed, as depicted in FIGS. 4 and 5. Similarly, in versions of the invention that include an adjustment unit 8, the apparatus 1 includes such, as further depicted in FIGS. 4 and 5. Finally, again with reference to FIGS. 4-5, the spacer unit 10 may be included for selective and automatic control of the spacing between the exit point of jet/beam A of the generator 3 in inscribing module 12, and the cable 2.

As will also be well understood from the immediately foregoing description, versions of the invention in which the direction of the jet A may be changed in one or more axes in space, as explained previously and with reference to FIGS. 2c and 2d, may appropriately omit one or more of the line movement unit 6, the adjustment unit 8, and the spacer unit 10. In such versions, the inscribing module 12 may include the jet/beam generator 3 along with a cardanic mount, a laser, a mirror, or pole plate, as appropriate to the particular version of the invention, as previously described.

FIGS. 6 and 7 depict in greater detail an advantageous implementation of versions of the invention, in further development from the context of FIGS. 4-5, wherein like reference numerals refer to similar components. In FIGS. 6 and 7 the apparatus 1 is depicted in isolational elevational perspectives taken from opposite sides. In both views, the inscribing module 12 is shown as mounted so as to be selectively and controllably moved via automatic control of line movement unit 6. The control of the orientation of direction a is effected by an adjustment unit that may be connected to a mounting block 16. As seen in both views, FIGS. 6 and 7, an adjustment shaft 18 is automatically controlled in rotation by the adjustment unit to act on arcuate gearing 24 and thus automatically control rotation of the plane in which the jet A is moved relative to the cable axis, about an axis normal to the cable axis. By automatically controlling the adjustment unit in this manner, the speed component VSy of the jet movement in the region of the cable 2 in the direction of the cable axis y is controlled to correspond to the speed VL of the cable 2. The spacer unit 10 is automatically controlled so as to provide automatic control of the spacing between the exit point of the jet A of the jet generator 3, and the cable 2.

In the context of the foregoing description and the appended claims, it should be understood that the term “connected” is used in an operational sense and is not necessarily limited to a direct physical connection or coupling. Thus, for example, two devices may be connected directly, or via one or more intermediary structures, media or devices. As another example, devices may be connected in such a way that information can be passed there between, while not sharing any physical connection on with another. Based on the disclosure provided herein, one of ordinary skill in the art will appreciate a variety of ways in which connection exists in accordance with the forementioned definition. Furthermore, in the context of the appended claims, the terms “jet” and “beam” may be interchangeably and equivalently used, without distinction, to identically indicate the inscribing stream acting on a cable to inscribe it.

### LIST OF REFERENCE NUMERALS

1 Apparatus
2 Cable
3 Jet/beam generator
6 Line movement unit
8 Adjustment unit
10 Spacer unit
12 Inscribing module
14 Cable driving unit
16 Mounting block for adjustment unit
18 Adjustment shaft
20 Mounting plate
22 Frame
24 Arcuate gearing
a Direction of movement of the inscription jet/beam
A jet/beam for inscription
P, P1 . . . P4 Picture element/pixel
VL Speed of the cable
VS Speed of movement of the jet/beam
VSy Component of VS in the direction of the cable axis
x x coordinate
y y coordinate, cable axis
z z coordinate

What is claimed is:

1-12. (canceled)

13. Apparatus for inscribing a cable, comprising:
a jet generator configured to generate an inscribing jet for cable; and,
a movement unit configured to move the jet in a direction transverse to cable axis and controllably adjust this direction to correspond the speed of the cable to a cable-axis-direction speed component of the jet in the region of the cable axis, during inscription.

14. An apparatus for inscribing a cable as claimed in claim 13, further comprising:
an exit location for the jet, said exit location being on said generator; and,
said movement unit operatively connected to displace said exit location transverse to the cable axis, during inscription of cable.

15. The apparatus for inscribing a cable as claimed in claim 14, wherein:
said movement unit is operatively connected to displace said exit location in the cable axis direction, during inscription.

16. An apparatus for inscribing a cable as claimed in claim 14, further comprising:
a line movement unit configured to move said generator in a plane transverse to the cable axis during inscription; and,
an adjustment unit configured to adjust said line movement unit and the plane transverse to the cable axis to correspond speed of the cable to a cable-axis-direction speed component of said line movement unit, during inscription.

17. The apparatus for inscribing a cable as claimed in claim 16, wherein:
said exit location is disposed so that a connecting line between said exit location and the point of intersection of the cable axis with the plane transverse to the cable axis forms a right angle with the cable axis.

18. An apparatus for inscribing a cable as claimed in claim 14, further comprising:
a spacer unit configured to controllably change spacing between said exit location and cable.

19. An apparatus for inscribing a cable as claimed in claim 14, further comprising:
a controller connected to control said apparatus; and,
a memory unit in operative communication with said controller, said memory unit storing, for a type of cable, at least one parameter selected from the group consisting of: direction of movement of the jet, spacing between said exit location and cable, size of inscription, and offset of inscription relative to cable axis.

20. An apparatus for inscribing a cable as claimed in claim 14, further comprising:
a controller connected to control said apparatus; and,
in operative communication with said controller, a calculating processor configured to calculate, on the basis of a parameter characterizing a cable, at least one parameter selected from the group consisting of: direction of movement of the jet, spacing between said exit location and cable, size of inscription, and offset of inscription relative to cable axis.

21. An apparatus for inscribing a cable as claimed in claim 13, further comprising:
an exit location for the jet, said exit location being on said generator; and,
said movement unit configured to controllably change the direction of a jet exiting from said exit location.

22. An apparatus for inscribing a cable as claimed in claim 21, further comprising:
said movement unit controllably changes, during inscription, the direction of a jet from said exit location in a path transverse to the cable axis; and,
an adjustment unit configured to adjust said movement unit during inscription to automatically control the angle between said path and the cable axis.

23. An apparatus for inscribing a cable as claimed in claim 21, further comprising:
a cardanic mount connected to said jet generator.

24. An apparatus for inscribing a cable as claimed in claim 21, further comprising:
a controlled mirror disposed to selectively change the direction of said jet from said exit location.

25. An apparatus for inscribing a cable as claimed in claim 21, further comprising:
a controlled pole plate disposed to selectively change the direction of said jet from said exit location.

26. An apparatus for inscribing a cable as claimed in claim 21, further comprising:
a controlled electrostatic field generator disposed to selectively change the direction of said jet from said exit location.

27. An apparatus for inscribing a cable as claimed in claim 21, further comprising:
a spacer unit configured to controllably change spacing between said exit location and cable.

28. An apparatus for inscribing a cable as claimed in claim 21, further comprising:
a controller connected to control said apparatus; and,
a memory unit in operative communication with said controller, said memory unit storing, for a type of cable, at least one parameter selected from the group consisting of: direction of movement of the jet, spacing between said exit location and cable, size of inscription, and offset of inscription relative to cable axis.

29. An apparatus for inscribing a cable as claimed in claim 21, further comprising:
a controller connected to control said apparatus; and,
in operative communication with said controller, a calculating processor configured to calculate, on the basis of a parameter characterizing a cable, at least one parameter selected from the group consisting of: direction of movement of the jet, spacing between said exit location and cable, size of inscription, and offset of inscription relative to cable axis.

30. An apparatus for inscribing a cable, comprising:
an inscribing module;
a jet generator in said inscribing module;
a line movement unit configured to controllably move said inscribing module in a direction transverse to a cable axis during cable inscription by said jet generator;
an adjustment unit configured to controllably adjust, during cable inscription by said jet generator, an angle between said direction transverse to a cable axis in which said inscribing module moves, and said cable axis;
said adjustment unit connected to a rotary shaft;
said rotary shaft driving at least one arcuate gear;
said arcuate gear connected to a mount for said inscribing module;
a spacer unit configured to controllably change spacing between said jet generator and a cable being inscribed; and,
a controller controlling said line movement unit and said adjustment unit to automatically correspond speed of moving cable being inscribed to a cable-axis-direction speed component of said line movement unit.

31. An apparatus for inscribing a cable, comprising:
an inscribing module;
a jet generator configured to generate a cable-inscribing jet, said jet generator being pivotably mounted to pivot around a pivot axis in said inscribing module;
an adjustment unit configured to controllably adjust, during cable inscription by said jet generator, an angle between the pivot axis of said pivotably mounted jet generator and the cable axis;
said adjustment unit connected to a rotary shaft;
said rotary shaft driving at least one arcuate gear;
said arcuate gear connected to a mount for said inscribing module;
a spacer unit configured to controllably change spacing between said jet generator and a cable being inscribed; and,
a controller connected to control pivotal movement of said jet generator and also said adjustment unit to automatically correspond speed of moving cable being inscribed to a speed component, in cable axis direction, of a jet generated by said jet generator.

32. An apparatus for inscribing a cable, comprising:
an inscribing module;
a jet generator configured to generate a cable-inscribing jet, said jet generator being cardanically pivotably mounted to pivot in said inscribing module;
a spacer unit configured to controllably change spacing between said jet generator and a cable being inscribed; and,
a controller connected to control pivotal movement of said jet generator and direction of a jet exiting from said generator, said controller automatically corresponding the speed of moving cable being inscribed to a speed component, in cable axis direction, of the jet generated by said jet generator.
